(19) United States
(12) Patent Application Publication
(10) Pub. No.: US 2020/0240356 A1
(43) Pub. Date: Jul. 30, 2020

(54) WORKING PISTON FOR A RECIPROCATING PISTON INTERNAL COMBUSTION ENGINE AND METHOD FOR THE PRODUCTION THEREOF

(71) Applicant: SLS TECHNOLOGIES GMBH, Dresden (DE)

(72) Inventor: Werner SCHÜTZE, Berlin (DE)

(73) Assignee: SLS TECHNOLOGIES GMBH, Dresden (DE)

(21) Appl. No.: 16/492,388

(22) PCT Filed: Mar. 7, 2018
(86) PCT No.: PCT/EP2018/055554

§ 371 Date: Dec. 27, 2019

(30) Foreign Application Priority Data
Mar. 7, 2017 (DE) 10 2017 104 741.7

(51) Int. Cl. F02F 3/14; B23K 26/352

(52) U.S. Cl. CPC F02F 3/14; F02B 77/02; B23K 26/355

(57) ABSTRACT

A working piston for a reciprocating internal combustion engine having a piston head. In order to further reduce pollutant emissions, soot particle emissions and the fuel consumption of the reciprocating piston internal combustion engine, the piston head has a wave-like structure which is circular and which is arranged concentric to the longitudinal central axis of the working piston and has nanostructuring at least in regions.

The invention relates to a working piston for a reciprocating-piston internal combustion engine, comprising a piston crown, and to a method for producing a working piston of a reciprocating-piston internal combustion engine.

A conventional working piston of a reciprocating-piston internal combustion engine comprises a piston crown with a smooth surface which exhibits a low capacity for evaporation of fuel droplets that come into contact therewith and a low capacity for reflection of thermal radiation. This is associated with increased fine dust emissions (unburned fuel droplets, oil particles and soot particles) and higher pollutant emissions (HC, CO, NOx) of the reciprocating-piston internal combustion engine.

DE 10 2012 113 225 A1 discloses a working piston for a reciprocating-piston internal combustion engine, on the piston crown of which there is arranged a coating into which catalytically active particles are incorporated. The coating comprises pores with increased dimensions in relation to conventional metallic combustion chamber surfaces. In this way, a faster and complete combustion of an ignitable mixture, composed of a fuel, air and possibly recirculated exhaust gas, which is injected into a combustion chamber is possible, in particular because the fuel is more effectively evaporated, and thus the number of droplets in the ignitable mixture situated in the combustion chamber is reduced. This is associated with an increase in efficiency or of the power of the reciprocating-piston internal combustion engine. Furthermore, fine dust and soot particle emissions of the reciprocating-piston internal combustion engine can be reduced. Oil particles situated in the combustion chamber can also be burned. Furthermore, the fuel consumption of the reciprocating-piston internal combustion engine is reduced.

It is an object of the invention to further reduce pollutant emissions, soot particle emissions and/or the fuel consumption of a reciprocating-piston internal combustion engine.

Said object is achieved by means of the device and the method of the independent claims. Advantageous embodiments are specified in the following description, in the dependent claims and in the figures, wherein these embodiments may constitute a refining or advantageous aspect of the invention individually or in various technically expedient combinations of at least two of these embodiments with one another. Here, embodiments of the working piston may correspond to embodiments of the method, and vice versa, even if this is not explicitly pointed out below in the individual case.

A working piston according to the invention for a reciprocating-piston internal combustion engine comprises a piston crown, which comprises an undulation structure which is of substantially circular form and which is arranged substantially concentrically with respect to the longitudinal central axis of the working piston and which is equipped at least in certain regions with a nanostructuring.

This can be understood to mean that the piston crown comprises concentric undulation peaks and undulation troughs around a common central point, which may be the central point of the piston crown. This may have the appearance of the wave structure around a stone thrown into a lake. The undulation structure can be understood as a microstructure, which means that the undulations may have a period in the micrometer range. Adjacent undulation peaks of the microstructure may for example lie 5 to 150 micrometers apart.

This concentric undulation structure has a nanostructuring at least in certain regions. This can be understood to mean that the circular undulation structure in the micrometer range has a nanostructuring superposed on it. Nanostructuring can be understood to mean that the undulations have a period in the nanometer range. Adjacent undulation peaks of the nanostructuring may for example lie 500 to 1000 nanometers apart. The nanostructuring may likewise be undulating.

As a result, it is thus possible for an undulation structure in the micrometer range to have an undulation structure in the nanometer range superposed thereon. A single undulation of the undulation structure in the micrometer range may thus have numerous smaller undulations in the nanometer range.

The circular undulation structure and the partial or complete nanostructuring thereof lead to an enlargement of the surface of the piston crown. In particular, a surface enlargement by a factor of for example 3 to 10 is possible in relation to a smooth piston crown.

Owing to the larger surface of the piston crown according to the invention, near-complete to complete evaporation of the fuel droplets that come into contact with the piston crown is possible. Furthermore, the larger surface of the piston crown is associated with an improved heat absorption capacity of the working piston. Furthermore, the circular undulation structure improves the combustion of the mixture of fuel, air and possibly recirculated exhaust gas and/or water or the like, which is introduced into a combustion chamber, in the direction of a conventional inlet swirl flow within the mixture. The undulation structure of circular form and the nanostructuring may generate a system composed of vortices and micro-vortices on the piston crown, which lead to easier sliding of the (laminar) flow of the above-stated mixture over the vortices and micro-vortices and the piston crown. In this way, a type of “self-lubricating effect” can be achieved, which reduces both the resistance of the flow and the introduction of energy and heat from the mixture into the piston crown.

The circular undulation structure and the nanostructuring thereof are generated by means of different laser radiation in the micrometer range and nanometer range respectively, which furthermore effects laser activation of the surface of the piston crown.

By means of the nanostructuring of the circular undulation structure using a laser, so-called laser activation of the surface of the piston crown can be achieved. By means of the laser, alloy constituents of the piston material at the phase boundaries or grain boundaries of the piston material are released. The released alloy constituents at least partially form corresponding oxides. These oxides have catalytic action for components in the mixture introduced into the combustion chamber, and thereby lead to faster and complete combustion of the mixture. Furthermore, at the phase boundaries, nitrides or carbides can be produced from the alloy constituents of the piston material, which nitrides or carbides likewise have a correspondingly catalytic action. Examples of catalytically active materials that can be correspondingly produced are aluminum oxide, titanium oxide, titanium nitride, chromium oxide and vanadium oxide. In other words, the nanostructuring by means of a laser can lead to oxide, nitride and/or carbide formation at the grain boundaries, wherein the oxides, nitrides and/or carbides can catalytically lead to faster and complete combustion of the mixture. In this way, the surface of the piston crown is both enlarged and functionalized.

Thus, overall, by means of the circular undulation structure and the at least partial nanostructuring thereof, the combustion within the combustion chamber is improved, whereby pollutant emissions and soot particle emissions of the reciprocating-piston internal combustion engine, and the fuel consumption thereof, are reduced. Furthermore, owing to the faster and complete combustion of the mixture, the expenditure of time for fuel preparation, and a special engine setting for engines which output particularly low levels of pollutants, in particular low levels of nitrogen oxides, and/or which exhibit low consumption, are possible.

The nanostructuring may be formed as an undulating structuring. The undulating structuring, also referred to as ripple structuring, can be produced easily for example by means of a femtosecond laser. A ripple or riffle structuring may be understood to mean a quasi-periodic linear trench structure which forms as a result of interaction between incident laser radiation and the one or more materials of a substrate surface. As a structuring, various embodiments of a ripple structure, of a riffle structure, of a double ripple structure or of an interrupted double ripple structure may be provided. A double ripple structure may be of V-shaped form. It is however also possible for an interrupted double ripple structure or a single ripple structure to be of V-shaped design. The structuring may also be formed by at least two criss-crossing substructures of undulating form. The structuring of undulating form has a period in the nanometer range. The nanostructuring of the undulation structure may form a porous and catalytically active surface corresponding to DE 10 2012 113 225 A1.

The working piston may be formed as a steel piston or aluminum piston. The working piston may be newly produced or may be formed by machining of an existing working piston. The working piston may be used in a reciprocating-piston internal combustion engine in the form of a diesel engine or a gasoline engine.

Adjacent undulation peaks of the undulation structure may be arranged with a radial spacing of approximately 100 μm to one another. In one advantageous embodiment, adjacent undulation peaks of the undulation structure are arranged with a radial spacing between 5 and 150 micrometers to one another in the case of a piston diameter of between 5 to 150 mm. It has been found that the radial spacing of the undulation peaks preferably amounts to between 0.8 and 1.2% of the piston diameter. Surprisingly, the best spacing of the undulation peaks is dependent on the piston diameter.

The substantially circular undulation structure is accordingly a microstructure. “Substantially circular” is to be understood to mean not only an ideally circular undulation arrangement but all non-polygonal undulation arrangements and in particular oval, elliptical or ovoid undulation arrangements.

It is advantageous if side flanks of at least one undulation peak of the undulation structure run at an angle of approximately 50° to 65° or of approximately 60° with respect to one another. This angle range is distinguished by the fact that droplets that impinge on the surface evaporate in a particularly effective manner. This is owing to the fact that rebounding droplets are reflected directly onto the opposite undulation peaks. Additionally, thermal radiation from the side flanks is, in the case of this angle, reflected onto the adjacent side flank. It is preferable for multiple adjacent undulation peaks to be designed correspondingly.

A further advantageous embodiment provides for the nanostructuring to be of undulating form and to have a period which lies in a range from approximately 500 nm to approximately 1000 nm, in particular is approximately 700 nm. The nanostructuring may be formed using a femtosecond laser, the wavelength of which lies in a corresponding nanometer range.

The undulation structure is advantageously of hydrophilic form at least in certain regions. Droplets are thus absorbed and, in this way, absorb heat from the underlying surface, and evaporate, more effectively.

In a further advantageous embodiment, at least one undulation peak of the undulation structure is of rounded or flattened form in cross section. It has been found that an additional rounding reduces instances of misfiring.

In a further advantageous embodiment, a height of at least one undulation peak of the undulation structure periodically varies along the annular profile of the undulation peak. In this way, a mixture flow flowing along the piston crown can be elevated in relation to a smooth piston crown surface, whereby the friction between the mixture flow and the piston crown are reduced. In this way, a desired mixture flow along the piston crown is scarcely influenced by the contact with the piston crown. Furthermore, by means of this embodiment, the piston crown is provided with an increased capacity for reflecting incident thermal radiation, and an improved capacity for radiating heat, such that introduction of heat into the piston crown is reduced. Furthermore, this embodiment makes it possible for oil droplets that come into contact with the piston crown to also be combusted. Furthermore, this embodiment prevents deposition of oil carbon, which forms during the combustion, on the piston crown, whereby the fine dust emissions of the reciprocating-piston internal combustion engine are further reduced. It is also possible for all undulation peaks of the undulation structure to be designed correspondingly.

It is furthermore advantageous if at least one undulation peak of the undulation structure is formed by an encircling row of pyramid-shaped elevations. In this way, the height of the undulation peak varies periodically along the annular profile of the undulation peak. Each pyramid-shaped elevation may have a rhomboidal base area with diagonals of different length, wherein the longer diagonals may be oriented tangentially with respect to the annular profile of the undulation peak. It is also possible for all undulation peaks of the undulation structure to be designed correspondingly.

It is advantageous for at least one undulation peak of the undulation structure to be formed by an encircling row of rounded elevations which are arranged spaced apart from one another in encircling fashion. In this way, the height of the undulation peak varies periodically along the annular profile of the undulation peak. The rounded elevations may for example be of semicircular, circular-segment-shaped or semi-elliptical form in a side view. It is also possible for all undulation peaks of the undulation structure to be designed correspondingly.

It is furthermore considered to be advantageous if the working piston is of monolithic form, or if the working piston has a piston main body and a separately produced piston component which is arranged on the piston main body and which forms the piston crown. In the case of the latter embodiment, to form a working piston according to the invention, only the piston component has to be produced in accordance with the invention, whereas the piston main body can be of conventional form. It is thus also possible for a conventional piston, possibly after mechanical machining thereof, to be retrofitted with the piston component. The piston component may be connected to the piston main body in positive locking, non-positive locking and/or cohesive fashion.

In a method according to the invention for producing a working piston of a reciprocating-piston internal combustion engine, a piston crown of the working piston is produced with an at least partially nanostructured undulation structure which is of circular form and which is arranged concentrically with respect to the longitudinal central axis of the working piston.

The method for producing a working piston of a reciprocating-piston internal combustion engine may comprise the following steps:
providing a piston crown of a working piston, and
equipping the piston crown with an at least regionally nanostructured undulation structure which is of circular form and which is arranged concentrically with respect to the longitudinal central axis of the working piston.

The advantages stated above with reference to the working piston are correspondingly associated with the method. In particular, the working piston can be produced in accordance with one of the above-stated embodiments, or any desired technical expedient combination of at least two of said embodiments with one another, using the method.

In one advantageous embodiment, the undulation structure and the nanostructuring of the undulation structure are produced using laser radiation with different wavelengths. Here, the undulation structure may be formed using a femtosecond laser whose wavelength lies in a micrometer range, whereas the nanostructuring may be formed using a femtosecond laser whose wavelength lies in a nanometer range.

The invention will be discussed by way of example below with reference to the appended figures and on the basis of preferred embodiments, wherein the features presented below may, in each case individually and in various technically expedient combinations of at least two of said features with one another, constitute a refining or advantageous aspect of the invention. In the figures:

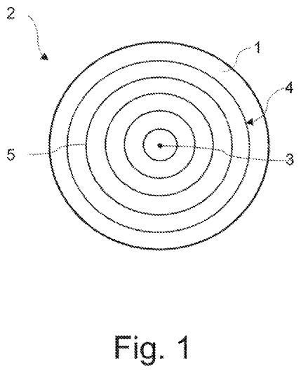

FIG. 1 shows a schematic plan view of a piston crown of an exemplary embodiment of a working piston according to the invention;

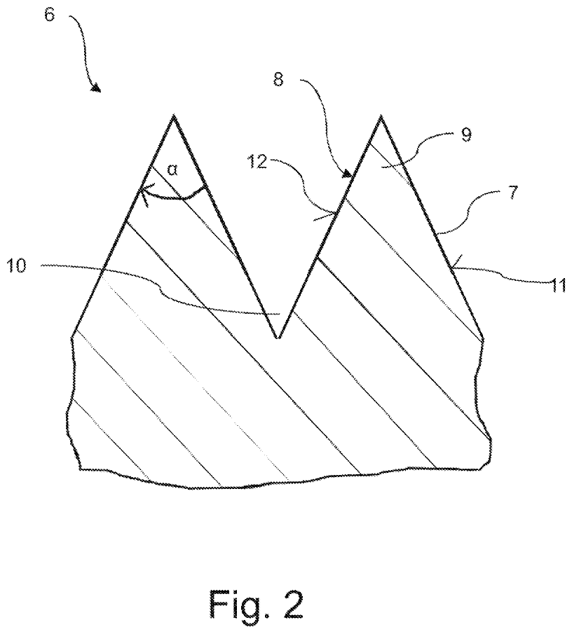

FIG. 2 is a schematic sectional illustration of a portion of a further exemplary embodiment of a working piston according to the invention;

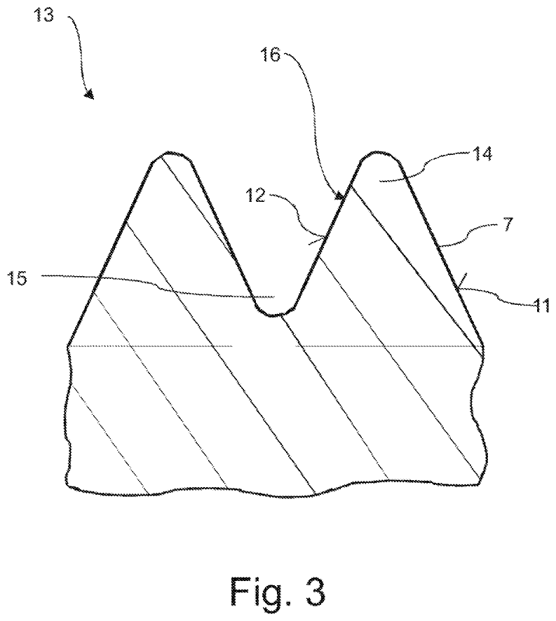

FIG. 3 is a schematic sectional illustration of a portion of a further exemplary embodiment of a working piston according to the invention;

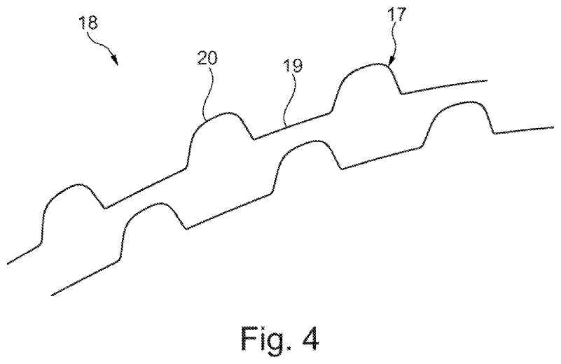

FIG. 4 is a schematic and perspective illustration of a portion of a circular undulation structure of a piston crown of a further exemplary embodiment of a working piston according to the invention;

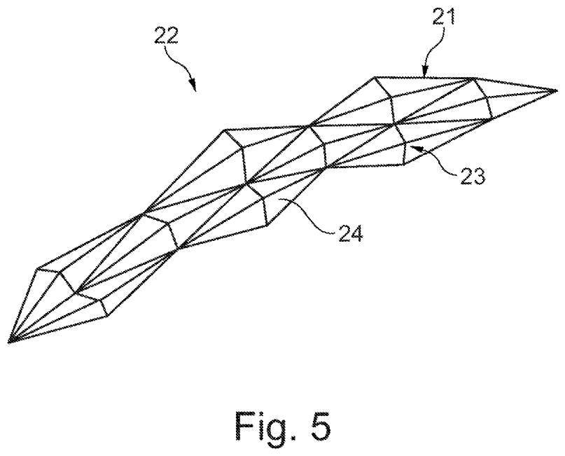

FIG. 5 is a schematic and perspective illustration of a portion of a circular undulation structure of a piston crown of a further exemplary embodiment of a working piston according to the invention; and

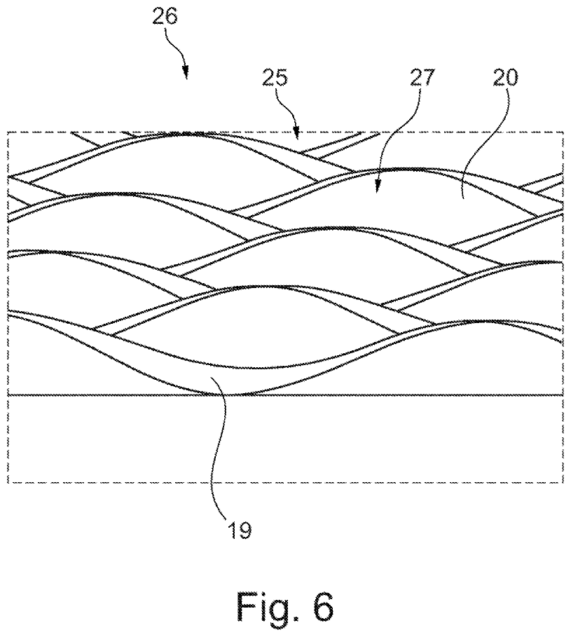

FIG. 6 is a schematic and perspective illustration of a portion of a circular undulation structure of a piston crown of a further exemplary embodiment of a working piston according to the invention.

Functionally identical or identical constituent parts are denoted in the figures by the same reference designations.

FIG. 1 shows a schematic plan view of a piston crown 1 of an exemplary embodiment of a working piston 2 according to the invention for a reciprocating-piston internal combustion engine (not shown).

The piston crown 1 comprises an undulation structure 4 which is of circular form and which is arranged concentrically with respect to the longitudinal central axis 3 of the working piston 2 and which is equipped at least in certain regions with a nanostructuring (not shown).

The undulation structure 4 comprises five undulation peaks 5, between which there are formed undulation troughs (not shown). Adjacent undulation peaks 5 of the undulation structure 4 may be arranged with a radial spacing of approximately 100 μm to one another. The side flanks (not shown) of each undulation peak 5 of the undulation structure 4 may run at an angle of approximately 60° with respect to one another. Furthermore, the undulation structure 4 may be of hydrophilic form at least in certain regions.

The nanostructuring of the undulation structure 4 may be of undulating form and have a period which lies in a range from approximately 500 nm to approximately 1000 nm, in particular is approximately 700 nm.

At least one undulation peak 5 of the undulation structure 4 may be of rounded or flattened form in cross section. A height of at least one undulation peak 5 of the undulation structure 4 may periodically vary along the annular profile of the undulation peak 5. In particular, the undulation peak 5 may be formed by an encircling row of pyramid-shaped elevations (not shown) or of rounded elevations (not shown) which are arranged spaced apart from one another in encircling fashion.

The working piston 2 may be of monolithic form. Alternatively, the working piston 2 may have a piston main body (not shown) and a separately produced piston component (not shown) which is arranged on the piston main body and which forms the piston crown 1.

FIG. 2 is a schematic sectional illustration of a portion of a further exemplary embodiment of a working piston 6 according to the invention for a reciprocating-piston internal combustion engine (not shown).

The working piston 6 comprises a piston crown 7, which piston crown comprises an undulation structure 8 which is of circular form and which is arranged concentrically with respect to the longitudinal central axis (not shown) of the working piston 6 and which is equipped at least in certain regions with a nanostructuring (not shown).

The undulation structure 8 comprises multiple undulation peaks 9, between which undulation troughs 10 are formed. Adjacent undulation peaks 9 of the undulation structure 8 may be arranged with a radial spacing of approximately 100 μm to one another. The side flanks 11 and 12 of each undulation peak 9 of the undulation structure 8 may run at an angle α of approximately 60° with respect to one another. The undulation structure 8, in particular the side flanks 11 and 12 thereof, may be of hydrophilic form at least in certain regions.

The nanostructuring may be of undulating form and may have a period which lies in a range from approximately 500 nm to approximately 1000 nm, in particular is approximately 700 nm.

A height of at least one undulation peak 9 of the undulation structure 8 may periodically vary along the annular profile of the undulation peak 9. In particular, the undulation peak 9 may be formed by an encircling row of pyramid-shaped elevations (not shown) or of rounded elevations (not shown) which are arranged spaced apart from one another in encircling fashion.

The working piston 6 may be of monolithic form. Alternatively, the working piston 6 may have a piston main body (not shown) and a separately produced piston component (not shown) which is arranged on the piston main body and which forms the piston crown 7.

FIG. 3 is a schematic sectional illustration of a portion of a further exemplary embodiment of a working piston 13 according to the invention for a reciprocating-piston internal combustion engine (not shown). The working piston 13 differs from the exemplary embodiment shown in FIG. 2 in that the undulation peaks 14 and the undulation troughs 15 of the undulation structure 16 are of rounded form in cross section. The respective rounding has a radius which may lie in a range from approximately μm to approximately 30 μm. To avoid repetitions, reference is otherwise made to the above description relating to FIG. 2.

FIG. 4 shows a schematic and perspective illustration of a portion of a circular undulation structure 17 of a piston crown 18 of a further exemplary embodiment of a working piston according to the invention (not shown in any more detail) of a reciprocating-piston internal combustion engine (not shown).

The undulation structure 17 is arranged concentrically with respect to the longitudinal central axis (not shown) of the working piston and is equipped at least in certain regions with a nanostructuring (not shown). The undulation structure 17 comprises multiple undulation peaks 19, between which there are formed undulation troughs (not shown). Adjacent undulation peaks 19 of the undulation structure 17 may be arranged with a radial spacing of approximately 100 μm to one another. Side flanks (not shown) of each undulation peak 19 may run at an angle of approximately 60° with respect to one another. The undulation structure 8, in particular the side flanks 11 and 12 thereof, may be of hydrophilic form at least in certain regions.

The nanostructuring may be of undulating form and have a period which lies in a range from approximately 500 nm to approximately 1000 nm, in particular is approximately 700 nm.

The height of each undulation peak 19 periodically varies along the annular profile of the undulation peak 19. In particular, each undulation peak 19 is formed by an encircling row of rounded elevations 20 which are arranged spaced apart from one another in encircling fashion. The elevations of one undulation peak 19 are arranged so as to be circumferentially offset relative to the elevations 20 of an adjacent undulation peak 19. At least one undulation peak 19 may be of rounded or flattened form in cross section.

The working piston may be of monolithic form. Alternatively, the working piston may have a piston main body (not shown) and a separately produced piston component (not shown) which is arranged on the piston main body and which forms the piston crown 18.

FIG. 5 is a schematic and perspective illustration of a portion of a circular undulation structure 21 of a piston crown 22 of a further exemplary embodiment of a working piston according to the invention (not shown in any more detail) of a reciprocating-piston internal combustion engine (not shown). The undulation structure 21 differs from the exemplary embodiment shown in figure in that each undulation peak 23 is formed by an encircling row of pyramid-shaped elevations 24. Each pyramid-shaped elevation 24 comprises a rhomboidal base area (not shown) with diagonals of different length, wherein the longer diagonal is oriented tangentially with respect to the annular profile of the respective undulation peak 23. To avoid repetitions, reference is otherwise made to the above description relating to FIG. 4.

FIG. 6 is a schematic and perspective illustration of a portion of a circular undulation structure 25 of a piston crown 26 of a further exemplary embodiment of a working piston according to the invention (not shown in any more detail) of a reciprocating-piston internal combustion engine (not shown). The undulation structure 25 differs from the exemplary embodiment shown in FIG. 4 in particular in that each undulation peak 27 is of flattened form. To avoid repetitions, reference is otherwise made to the above description relating to FIG. 4.

### LIST OF REFERENCE DESIGNATIONS

1 Piston crown
2 Working piston
3 Longitudinal central axis
4 Undulation structure
5 Undulation peak
6 Working piston
7 Piston crown
8 Undulation structure
9 Undulation peak
10 Undulation trough
11 Side flank
12 Side flank
13 Working piston
14 Undulation peak
15 Undulation trough
16 Undulation structure
17 Undulation structure
18 Piston crown
19 Undulation peak
20 Rounded elevation
21 Undulation structure
22 Piston crown
23 Undulation peak
24 Pyramid-shaped elevation
25 Undulation structure
26 Piston crown
27 Undulation peak

1. A working piston for a reciprocating-piston internal combustion engine, comprising a piston crown, wherein the piston crown comprises an undulation structure which is of circular form and which is arranged concentrically with respect to the longitudinal central axis of the working piston and which is equipped at least in certain regions with a nanostructuring.

2. The working piston as claimed in claim 1, wherein a radial spacing of adjacent undulation peaks of the undulation structure amounts to between 0.8 and 1.2% of a diameter of the working piston.

3. The working piston as claimed in claim 1, wherein adjacent undulation peaks of the undulation structure are arranged with a radial spacing of between 5 and 150 μm to one another.

4. The working piston as claimed in claim 1, wherein side flanks of at least one undulation peak of the undulation structure run at an angle (α) of approximately 50° to 65° with respect to one another.

5. The working piston as claimed in claim 1, wherein the nanostructuring is of undulating form and has a period which lies in a range from approximately 500 nm to approximately 1000 nm, in particular is approximately 700 nm.

6. The working piston as claimed in claim 1, wherein the undulation structure (4, 8, 16, 17, 21, 25) is of hydrophilic form at least in certain regions.

7. The working piston as claimed in claim 1, wherein at least one undulation peak of the undulation structure is of rounded or flattened form in cross section.

8. The working piston as claimed in claim 1, wherein a rounding of the rounded undulation structure has a radius of between 20 and 30 μm.

9. The working piston as claimed in claim 1, wherein a height of at least one undulation peak of the undulation structure periodically varies along the annular profile of the undulation peak.

10. The working piston as claimed in claim 1, wherein an elevation of an undulation peak is arranged so as to be circumferentially offset in relation to an elevation of the adjacent undulation peak.

11. The working piston as claimed in claim 1, wherein at least one undulation peak of the undulation structure is formed by an encircling row of pyramid-shaped elevations.

12. The working piston as claimed in claim 10, wherein at least one undulation peak of the undulation structure is formed by an encircling row of rounded elevations which are arranged spaced apart from one another in encircling fashion.

13. The working piston as claimed in claim 1, wherein the working piston is of monolithic form, or in that the working piston comprises a piston main body and a separately produced piston component which is arranged on the piston main body and which forms the piston crown.

14. A method for producing a working piston of a reciprocating-piston internal combustion engine, comprising the following steps:
providing a piston crown of a working piston, and
equipping the piston crown with an at least regionally nanostructured undulation structure which is of circular form and which is arranged concentrically with respect to the longitudinal central axis of the working piston.

15. The method as claimed in claim 1, wherein the undulation structure and the nanostructuring of the undulation structure are produced using laser radiation with different wavelengths.
